(19) United States
(12) Patent Application Publication
(10) Pub. No.: US 2006/0027571 A1
(43) Pub. Date: Feb. 9, 2006

(54) Liquid heating apparatus and cleaning apparatus and method

(75) Inventors: Yuichi Miyoshi, Osaka (JP); Kou Sugano, Osaka (JP); Yasuo Satoh, Tochigi (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL, CO., LTD.

(21) Appl. No.: 11/187,923

(22) Filed: Jul. 25, 2005

(30) Foreign Application Priority Data
Aug. 5, 2004 (JP) 2004-229534

(51) Int. Cl. H05B 6/80

(52) U.S. Cl. 219/687

(57) ABSTRACT

Microwaves are applied to pure water stored in a pure water tank past at least one of the top section of the sealed pure water tank, the side sections thereof and the bottom section thereof, thereby heating the pure water in a non-contact manner.

### CROSS-REFERENCE TO RELATED APPLICATIONS

This application claims priority under 35 U.S.C. §119 on Patent Application No. 2004-229534 filed in Japan on Aug. 5, 2004, the entire contents of which are hereby incorporated by reference. The entire contents of Patent Application No. 2005-77350 filed in Japan on Mar. 17, 2005 are also incorporated by reference.

### BACKGROUND OF THE INVENTION

(1) Field of the Invention

The present invention relates to a liquid heating apparatus for providing a heated cleaning solution, a cleaning apparatus for cleaning objects, such as semiconductor substrates, using the heated cleaning solution, and a cleaning method using the same.

(2) Description of Related Art

In a semiconductor device fabrication process, yield reduction due to particles and metal impurities both deposited on semiconductor substrates has conventionally been a large problem. Therefore, the step of cleaning semiconductor substrates using a cleaning solution to remove these particles and metal impurities has been essential and significant for the fabrication of semiconductor devices.

There are typically used, as cleaning solutions for semiconductor substrates, cleaning solutions obtained by blending two or three kinds of solutions selected from the group of alkaline chemical solutions such as ammonia water, acidic chemical solutions such as sulfuric acid solution and hydrochloric acid solution, oxidizing-agent chemical solutions such as hydrogen peroxide solution and ozone water, and pure water at a predetermined mixing ratio. Furthermore, typically, the temperature of the cleaning solutions is increased to a predetermined temperature by heating these cleaning solutions using a heater, resulting in the improved cleaning performance of the cleaning solutions. In this way, contamination due to particles or metal impurities is effectively removed in a shorter time.

A known heating apparatus for heating cleaning solutions and chemical solutions and a known hot water production apparatus for heating pure water are disclosed in, for example, Japanese Unexamined Patent Publication No. 5-190523 and Japanese Unexamined Patent Publication No. 5-074755. In these known arts, an immersion heater tube is put into a tub containing a cleaning solution, a chemical solution or pure water to heat the cleaning solution, the chemical solution or the pure water. This has been well known.

As an example of known arts relating to a method for heating a cleaning or chemical solution or pure water, a heating apparatus for a cleaning or chemical solution and a hot water production apparatus, a heating method for, in particular, pure water and a hot water production apparatus will be described with reference to the drawings. The apparatuses each have the same structure even when a cleaning solution obtained by mixing a chemical solution and pure water is heated.

FIG. 12 is a schematic view showing a known hot water production apparatus for heating pure water. The hot water production apparatus according to a first known art as shown in FIG. 12 comprises a pure water tank 105 that can store pure water, a supply pipe 107 for supplying pure water to the pure water tank 105, a drain 108 for draining pure water, a lid 114 placed on the top of the pure water tank 105, a heater tube 112 disposed in the pure water tank 105, a heater wire 113 connected through a cable to a heater power supply 103 and mounted inside the heater tube 112, a liquid-level sensor 109 for sensing the liquid level in the pure water tank 105, and a temperature-measuring sensor 110 for measuring the temperature of the pure water in the pure water tank 105.

In the known hot water production apparatus shown in FIG. 12, pure water is supplied through the supply pipe 107 to the pure water tank 105, and at the time when the pure water is stored in the pure water tank 105 to a predetermined amount, the supply of the pure water is stopped. In this case, the amount of pure water to be supplied to the pure water tank 105 is adjusted by sensing the pure water stored in the pure water tank 105 using the liquid-level sensor 109. The liquid-level sensor 109 shown in FIG. 12 is of a system in which the liquid level is sensed by blowing nitrogen (N₂) out of a pipe and sensing that the N₂ pressure varies with the immersion of a N₂ exit in pure water. Otherwise, the liquid-level sensor 109 may be of a sensing system using electrostatic capacity or a sensing system using light scattering.

After pure water is stored in the pure water tank 105 to a predetermined amount, the heater power supply 103 is turned ON to heat the heater wire 113, and heat is transferred through the heater tube 112 to the pure water, thereby heating the pure water to a predetermined temperature. In order to prevent the heater wire 113 from coming into direct contact with the pure water and thus becoming electrically continuous with the pure water, the heater wire 113 is encapsulated in the heater tube 112. A metal resistance wire, such as a Nichrome wire and a Kanthal wire, is used for the heater wire 113, and quartz hardly causing contamination is often used for the heater tube 112. The temperature of the pure water in the pure water tank 105 is measured using the temperature-measuring sensor 110.

After the temperature of the pure water in the pure water tank 105 reaches a predetermined temperature, the output of the heater power supply 103 is controlled to maintain, at a predetermined temperature, hot water in the pure water tank 105. In order to prepare a cleaning solution, the pure water is drained from the drain 108, and then a chemical solution and the heated pure water are put into a separate preparation tank or cleaning tank at a predetermined mixing ratio. Thereafter, semiconductor substrates are put into the cleaning tank containing this cleaning solution and immersed in the cleaning solution for a predetermined period, thereby cleaning the semiconductor substrates.

Furthermore, another known art (second known art) is disclosed in, for example, Japanese Unexamined Patent Publication No. 7-302778. It is a system for heating a cleaning solution, a chemical solution and pure water using an infrared radiator, such as a halogen lamp, or a heater comprising an infrared radiator. This heater is obtained by replacing the heater wire 113 and heater tube 112 of the heater shown in FIG. 12 both for heating with a halogen lamp and has the same structure as the known heater shown in FIG. 12 except for the heater.

Furthermore, still another known art (third known art) is disclosed in, for example, Japanese Unexamined Patent Publication No. 57-148846. A heating apparatus of the third known art has a structure in which a cleaning solution is heated by applying microwaves from the outside of a pipe through which the cleaning solution flows to the cleaning solution.

### SUMMARY OF THE INVENTION

When a pinhole is produced in the heater tube 112 of the heating apparatus of the system in which the heater wire 113 surrounded by the heater tube 112 is put into the pure water tank 105 as shown in FIG. 12, pure water enters into the heater tube 112 so that the heater wire 112 makes contact with the pure water. This allows a metal component of the heater wire 113 to dissolve into the pure water or causes leaks or abnormal heating, leading to damage of the heater wire 113 and the heater tube 112. Furthermore, deterioration of the heater wire 113 itself over time may also cause the breakage of the heater wire 113 due to the abnormal heating and a break thereof and simultaneously the breakage of the heater tube 112. Thus, the heater wire 113 may be brought into contact with pure water so that a metal component of the heater wire 113 may dissolve into the pure water. In addition, during the maintenance or exchange of the heater wire 113 and the heater tube 112, the lid 114 of the pure water tank 105 need be opened to execute an operation for the maintenance or exchange. Not only the operation takes an effort but also during the operation, particles or metal contaminants may be mixed into the pure water tank 105 and particles or metal contaminants deposited on the outer surface of a new heater tube 112 may be mixed into the pure water tank 105.

A system of the second known art for emitting an infrared ray, such as a halogen lamp, has permitted the heating of not only pure water in a pure water tank but also an ambient atmosphere, such as ambient air. This has reduced the heating efficiency. Furthermore, since a heating apparatus cannot be installed in a cleaning apparatus dealing with a volatile chemical solution and thus need be installed outside the cleaning apparatus, space could not be saved.

It was difficult to heat a cleaning solution from room temperature to, for example, a high temperature of about 80° C. In a system of a third known art for heating the cleaning solution by irradiating the cleaning solution with microwaves from the periphery of a pipe through which the cleaning solution flows, because the cleaning solution is flowing. It is conceivable that, in order to heat, using the above system, the cleaning solution to a high temperature enough to clean semiconductor substrates, the flow rate of the cleaning solution should be reduced. However, it is difficult to reduce the flow rate of the cleaning solution, because the performance of the cleaning apparatus is decreased. Alternatively, it is also conceivable to irradiate the cleaning solution with high-power microwaves. However, since a high-power microwave heating apparatus is very expensive, it is practically difficult to employ the high-power microwave heating apparatus.

In view of the above, it is an object of the present invention to provide a liquid heating apparatus and a liquid heating method both for effectively heating pure water or a cleaning solution without any contamination, and cleaning apparatus and method utilizing the heating method.

The present invention is characterized in that liquid stored in a reservoir is heated by applying microwaves from the outside of the reservoir to the liquid in a non-contact manner.

More specifically, a liquid heating apparatus of the present invention comprises: a first reservoir for storing a first liquid; a supply passage for supplying the first liquid to the first reservoir; a drain for draining the first liquid from the first reservoir; a microwave oscillator for generating microwaves that can heat the first liquid; a waveguide for transmitting microwaves to the first reservoir and applying the microwaves to the first liquid past the first reservoir; and a microwave blocker for preventing microwaves from leaking out of the first reservoir.

Therefore, the first liquid can be heated without making contact with a heating unit. This can prevent contaminants from entering from the heating unit into the first liquid unlike the use of a thermally conductive heating unit, such as a heater, resulting in the first liquid heated with high efficiency. Furthermore, heating can start at the instant of applying microwaves and stop at the instant of stopping the microwave application, resulting in the first liquid heated with more excellent responsibility as compared with a thermally conductive heating method. Since the first liquid can be heated in a non-contact manner, the first reservoir can be sealed. This can further reduce the risk of contaminating the first liquid. Furthermore, the generated heat in the vicinity of the first reservoir can be reduced as compared with a heating method using an infrared lamp. This makes it possible to place the liquid heating apparatus in a cleaning apparatus for semiconductor substrates. Therefore, the use of the liquid heating apparatus of the present invention can make the cleaning apparatus compact.

The liquid heating apparatus of the present invention may further comprise a choke pipe attached to at least one of joints between the supply passage and the first reservoir and between the drain and the first reservoir and preventing the leakage of microwaves. This can reduce microwaves leaking out of the supply passage or the drain.

At least one of the supply passage and the drain may have a plurality of branches at the joint with the first reservoir, the diameter of each said branch being a quarter or less of the microwave wavelength. This can prevent microwaves from leaking out of the supply passage or the drain.

The liquid heating apparatus of the present invention may further comprise a chemical-agent barrier of a chemical-resistant material attached to a microwave radiation exit of the waveguide to prevent a chemical solution from entering into the waveguide. This can prevent a vaporized chemical solution from passing through the waveguide and reaching the microwave oscillator and the microwave oscillator from being broken.

The liquid heating apparatus of the present invention may further comprise a stirrer attached to a microwave radiation exit of the waveguide to scatter microwaves applied to the first reservoir. Therefore, microwaves can be applied to a wider area, resulting in the liquid heated with excellent efficiency.

The inner and outer surfaces of the waveguide may be coated with a chemical-resistant material. This can prevent the inner and outer surfaces of the waveguide from being attacked by the chemical solution.

The microwave blocker may be coated with a chemical-resistant material. This can prevent the microwave blocker from being attacked by the chemical solution.

A gas inlet duct may be provided for the waveguide, and a gas may be taken from the gas inlet duct to provide a positive pressure inside the waveguide. This can prevent a vaporized chemical solution from entering from a crack in the joint between the waveguide and the gas inlet duct into the waveguide. As a result, the waveguide can be prevented from being attacked by the vaporized chemical solution and the microwave oscillator can be prevented from being broken.

An inert gas is preferably used as a gas taken from the air inlet duct.

The liquid heating apparatus of the present invention may further comprise: a second reservoir for storing a second liquid; a branch waveguide that is branched from the waveguide to transmit microwaves generated by the microwave oscillator to the second reservoir and apply the microwaves to the second liquid past the second reservoir; and a movable microwave reflector element disposed at the junction between the waveguide and the branch waveguide and made of a material that reflects microwaves. Therefore, the second liquid in the second reservoir can be heated using microwaves during the period during which heating is not carried out in the first reservoir, thereby efficiently heating the liquid. Furthermore, even if the waveguide is extended to several tens of m, microwaves can be guided without being caused to attenuate. Therefore, this liquid heating apparatus is suitable for being combined with a cleaning apparatus having a plurality of reservoirs as compared with heating apparatuses using the other heating methods.

The waveguide is preferably made of a metal material.

The microwave blocker is preferably made of a metal material.

The first reservoir is preferably made of fluoroplastic or quartz.

In particular, the chemical-agent barrier is preferably made of fluoroplastic.

The waveguide may be connected to the bottom of the reservoir. Therefore, the first liquid can be heated while being stirred because of convection, resulting in the uniformly heated first liquid. This can make the temperature distribution of the first liquid uniform.

A cleaning apparatus of the present invention comprises a liquid heating unit for heating liquid and a cleaning unit having a cleaning tank for storing a cleaning solution, wherein the liquid heating unit comprises: a reservoir mounted in the cleaning unit to store liquid; a supply passage for supplying the liquid to the reservoir; a drain for draining the liquid from the reservoir; a microwave oscillator for generating microwaves that can heat the liquid; and a waveguide for transmitting microwaves to the reservoir and applying the microwaves to the liquid past the reservoir.

Therefore, the liquid can be heated without making contact with the heating unit. This can prevent contaminants from entering from the heating unit into the liquid unlike the use of a thermally conductive heating unit, such as a heater, resulting in the liquid heated with high efficiency. Therefore, for example, semiconductor substrates can be cleaned using the heated cleaning solution. Furthermore, heating can start at the instant of applying microwaves to the liquid and stop at the instant of stopping the microwave application, resulting in the liquid heated with more excellent responsibility as compared with a thermally conductive heating method. Moreover, when the microwave oscillator and its power supply are placed outside the cleaning unit, this improves the flexibility in the arrangement of the cleaning apparatus.

The whole liquid heating unit is preferably placed in the cleaning unit. This can make the cleaning apparatus compact.

The liquid stored in the reservoir may be one selected from the group of pure water, chemical solutions and the cleaning solution. Therefore, a hot cleaning solution can be prepared through various methods. For example, a cleaning solution may be prepared by mixing heated pure water with a chemical solution. Alternatively, a previously prepared cleaning solution may be heated.

The cleaning apparatus of the present invention may further comprise a circulating line which is connected to the cleaning tank and through which the cleaning solution in the cleaning tank circulates, wherein the reservoir may be placed somewhere along the circulating line and stores the cleaning solution circulated through the circulating line. This reduces the flow rate of the liquid as compared with the method in which the liquid is heated through the circulating line, resulting in the liquid heated with excellent efficiency. This can make the power of the microwave oscillator relatively small, leading to the reduced cost required for facilities for cleaning semiconductor substrates.

A cleaning method of the present invention uses a cleaning apparatus comprising a reservoir for storing liquid, a cleaning unit having a cleaning tank for storing a cleaning solution, a microwave oscillator for generating a first type of microwaves that can heat the liquid, a waveguide for transmitting the first type of microwaves to the reservoir and applying the first type of microwaves to the liquid past the reservoir. The method comprises the steps of: (a) storing the liquid in the reservoir; (b) applying the first type of microwaves to the liquid in the reservoir to heat the liquid; (c) delivering the liquid heated in the step (b) to the cleaning tank; and (d) storing the cleaning solution containing the liquid to the cleaning tank and cleaning an object to be cleaned.

With this method, the liquid can be heated without making contact with the heating unit. This can prevent contaminants from entering from the heating unit into the liquid as compared with the use of a thermally conductive heating unit, such as a heater. As a result, the liquid can be heated with high efficiency.

When the reservoir is placed somewhere along the circulating line, this can provide a cleaning solution efficiently heated using a relatively inexpensive microwave oscillator, because the cleaning solution delivered from the cleaning tank to the reservoir has already reached a desired processing temperature.

When the reservoir is provided separately from the cleaning tank, the cleaning apparatus may further comprise a first preparation tank, and the method may further comprise the step of, before the step (a), preparing the cleaning solution in the first preparation tank and delivering the cleaning solution to the reservoir.

Alternatively, the step (a) may include the step of supplying pure water and a chemical solution to the reservoir. Thus, a cleaning solution itself for cleaning can be heated to a desired temperature, resulting in the temperature of the cleaning solution controlled with high accuracy.

The liquid stored in the reservoir may be pure water, and the method may further comprise the step (e) of, between the steps (c) and (d), mixing the pure water and a chemical solution in the cleaning tank to prepare the cleaning solution.

The cleaning apparatus may further comprise a second preparation tank, the liquid stored in the reservoir may be pure water, and the method may further comprise the steps of: (f) delivering the heated pure water to the second preparation tank immediately after the step (b); (g) mixing the pure water and a chemical solution in the second preparation tank to prepare the cleaning solution; and (h) delivering the cleaning solution prepared in the step (g) to the cleaning tank.

In the step (b), a second type of microwaves with a different frequency from that of the first type of microwaves may be applied to the liquid in the reservoir. Therefore, a large amount of liquid can be heated or a liquid can be heated at high speed. The shift of the frequency of the first type of microwaves from that of the second type of microwaves can prevent the two microwaves from canceling each other.

### BRIEF DESCRIPTION OF THE DRAWINGS

FIG. 1 is a schematic view showing an example of a hot water production apparatus according to a first embodiment of the present invention.

FIG. 2 is a schematic view showing an example of the hot water production apparatus according to the first embodiment of the present invention when a system of a liquid-level sensor is changed into another system.

FIG. 3 is a partially enlarged view showing a specific structure of a choke pipe of the hot water production apparatus according to the first embodiment.

FIG. 4 is a schematic view showing an example of the hot water production apparatus according to the first embodiment when a supply pipe and a drain are changed in shape.

FIG. 5 is an enlarged cross-sectional view showing the vicinity of a microwave exit of a waveguide of the hot water production apparatus according to the first embodiment.

FIG. 6 is a cross-sectional view showing an example of the hot water production apparatus according to the first embodiment when a gas is taken into a waveguide.

FIG. 7 is a schematic view partly showing the hot water production apparatus of the first embodiment when microwaves are applied to pure water past the bottom of a pure water tank.

FIG. 8 is an enlarged cross-sectional view partly showing the hot water production apparatus of the first embodiment when a stirrer for microwave scattering is mounted at the exit of the waveguide.

FIG. 9 is a schematic view showing an example of a hot water production apparatus according to a second embodiment of the present invention.

FIG. 10 is a schematic view showing an example of a hot water production apparatus according to a third embodiment of the present invention.

FIG. 11 is a schematic view showing an example of a cleaning solution heating apparatus and a cleaning apparatus according to a fourth embodiment of the present invention.

FIG. 12 is a schematic view showing a known hot water production apparatus for heating pure water.

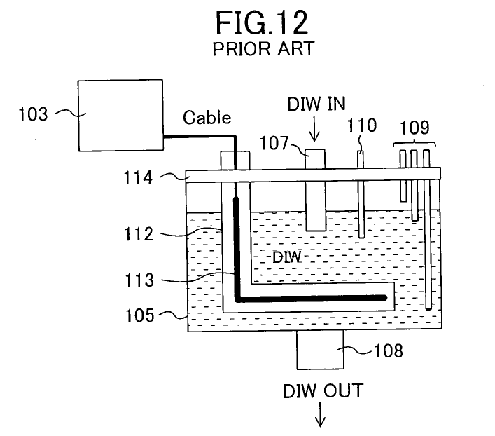

### DETAILED DESCRIPTION OF THE INVENTION

A liquid heating apparatus (hot water production apparatus/cleaning solution heating apparatus), a cleaning apparatus and a cleaning method of the present invention are characterized by indirectly heating liquid stored in a tank using microwaves. A liquid heating apparatus (hot water production apparatus), a cleaning apparatus and a cleaning method according to each of embodiments of the present invention will be described hereinafter with reference to the drawings.

### Embodiment 1

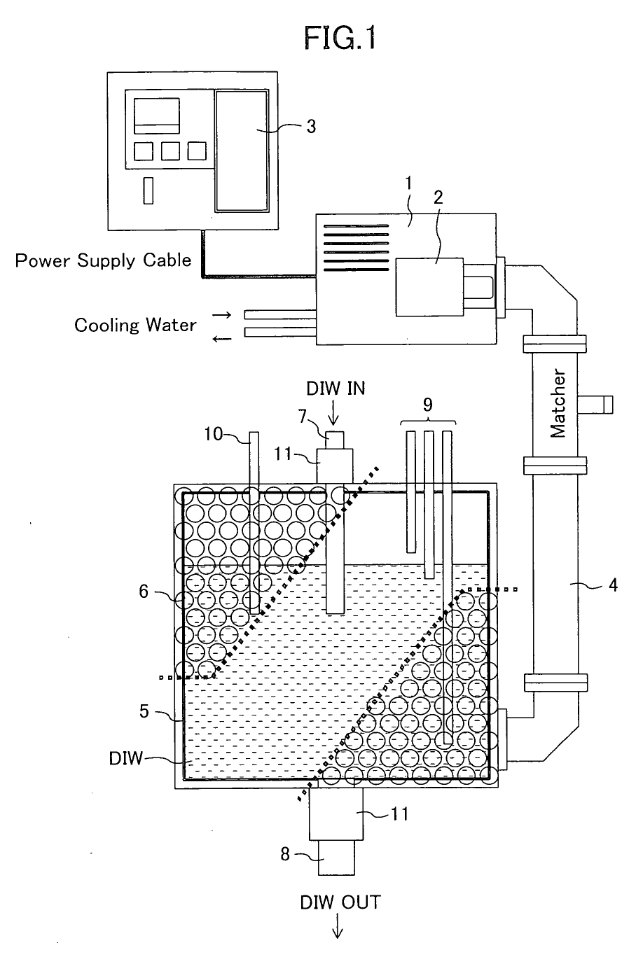

FIG. 1 is a schematic view showing an example of a hot water production apparatus according to a first embodiment of the present invention. This hot water production apparatus is used to produce hot water for preparing, for example, a high-temperature cleaning solution for semiconductor devices.

As shown in FIG. 1, a hot water production apparatus (liquid heating apparatus) of this embodiment comprises a pure water tank (reservoir) 5 for storing pure water (liquid), a supply pipe (supply passage) 7 for supplying pure water to the pure water tank 5, a drain 8 for draining pure water, a power supply 3, a microwave oscillator 1 connected through a cable to the power supply 3 and having a magnetron 2 that generates microwaves, a waveguide 4 that transmits the microwaves generated from the microwave oscillator 1 to the pure water tank 5 and irradiates the pure water tank 5 with microwaves, a microwave blocking plate (microwave blocker) 6 surrounding the entire surfaces of the pure water tank 5 and preventing the leakage of microwaves, a liquid-level sensor 9 for sensing the liquid level in the pure water tank 5, a temperature-measuring sensor 10 for sensing the temperature of the pure water in the pure water tank 5, and choke pipes 11 mounted at respective joints between the supply pipe 7 and the pure water tank 5 and between the drain 8 and the pure water tank 5 to prevent the leakage of microwaves. The functions and detailed structures of components of the hot water production apparatus will be described hereinafter in turn.

In order to produce hot water, pure water is supplied through the supply pipe 7 to the pure water tank 5 shown in FIG. 1, the pure water stored in the pure water tank 5 is sensed by the liquid-level sensor 9, and at the time when the pure water is stored in the pure water tank 5 to a predetermined amount, the supply of the pure water is stopped. The liquid-level sensor 9 has pipes through which N₂ is blown and employs a system in which the liquid level is sensed by sensing that the N₂ pressure varies with the immersion of a N₂ exit of each pipe in pure water. In order to prevent the leakage of microwaves from these N₂ pipes, the diameter of each N₂ pipe is preferably a quarter or less of the microwave wavelength. Microwaves are generally used which each have a frequency of 2.45 GHz (a wavelength of 12 cm) within the legal limit (2.4 through 2.5 GHz). Therefore, the diameter of the N₂ pipe is 3 cm or less.

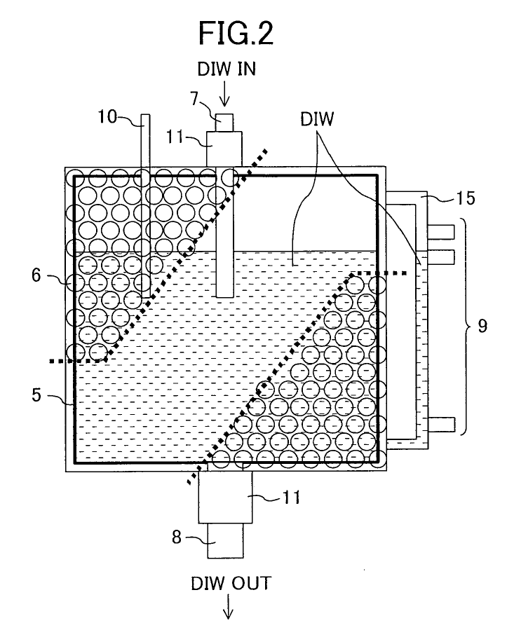

FIG. 2 is a schematic view showing an example of the hot water production apparatus of this embodiment when the system of the liquid-level sensor is changed into another system. As shown in FIG. 2, a liquid-level sensor of a sensing system using electrostatic capacity or a sensing system using light scattering may be mounted instead of a liquid-level sensor of a N₂-blow-type sensing system. In this case, as shown in FIG. 2, in order to avoid the influence of microwaves, the liquid level need be sensed by extending a pure water tank 5 toward the outside of a microwave blocking plate 6 to provide a pure water pipe 15 for sensing the liquid level and thus mounting a liquid-level sensor using electrostatic capacity or light scattering to the pure water pipe 15.

In order to fill the pure water tank 5 with pure water or drain pure water in a shorter time, a supply pipe 7 and a drain 8 both connected to the pure water tank 5 normally require a flow rate of a few tens of L/min. This increases the diameters of the supply pipe 7 and the drain 8. Therefore, it is difficult to set the pipe and drain to each have a diameter of a quarter or less of the microwave wavelength, i.e., the diameter that allows microwaves to be blocked. Therefore, in order to reduce the leakage of microwaves from the supply pipe 7 and the drain 8, the hot water production apparatus of this embodiment is provided with choke pipes 11 to reflect microwaves entering into the supply pipe 7 and the drain 8, resulting in the reduced leakage of microwaves.

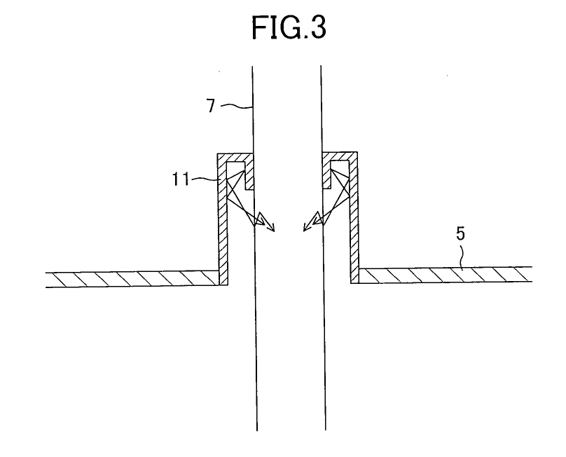

FIG. 3 is a partial enlarged view showing a specific structure of a choke pipe 11. As shown in FIG. 3, a choke pipe 11 is made of a material that reflects microwaves, such as metal, and has a shape in which the end of the pipe wall is folded inwardly (to extend along the supply pipe 7). This structure allows microwaves having leaked through the supply pipe 7 or the drain 8 toward the choke pipe 11 to reflect on folded parts of the choke pipe 11 and move toward the pure water tank 5. This makes it difficult that the microwaves leak to the outside.

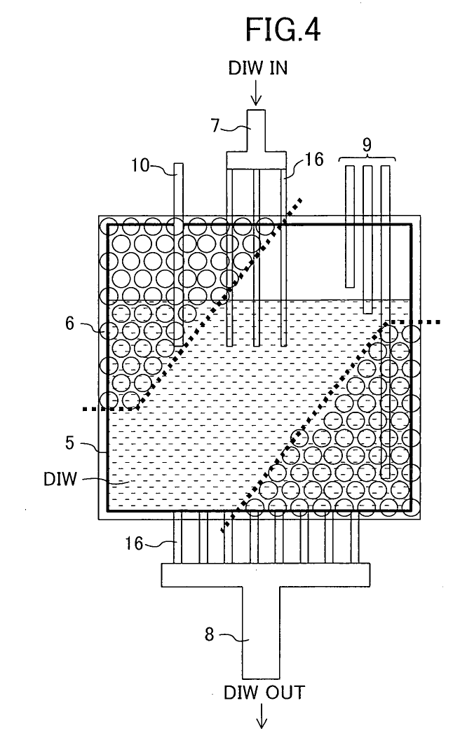

FIG. 4 is a schematic view showing an example of the hot water production apparatus of this embodiment when a supply pipe and a drain are changed in shape. In order to more completely block the leakage of microwaves from the supply pipe 7 and the drain 8, as shown in FIG. 4, the supply pipe 7 and the drain 8 are branched into at least two pipes 16 immediately before being connected to the pure water tank 5. The diameter of each branched pipe 16 may be set to be a quarter or less of the wavelength of each microwave applied to the pure water tank 5. If the plurality of branched pipes 16 are connected to the pure water tank 5, the leakage of microwaves can more completely be blocked while the amount of pure water to be supplied and drained to/from the pure water tank 5 can be ensured enough.

After pure water is stored in the pure water tank 5 to a predetermined amount, a power supply 3 is turned ON to operate a microwave oscillator 1, thereby generating microwaves from a magnetron 2. The generated microwaves move into a waveguide 4 while reflecting thereon and is applied from the exit of the waveguide 4 to the pure water tank 5. The applied microwaves penetrate through the pure water tank 5 so as to be absorbed in the pure water, resulting in vibrated water molecules of the pure water. As a result, the pure water is heated. The pure water in the pure water tank 5 is measured in temperature using a temperature-measuring sensor 10. In order to prevent the leakage of microwaves from the pure water tank 5 to the outside, the entire surfaces of the pure water tank 5 are surrounded by the microwave blocking plate 6.

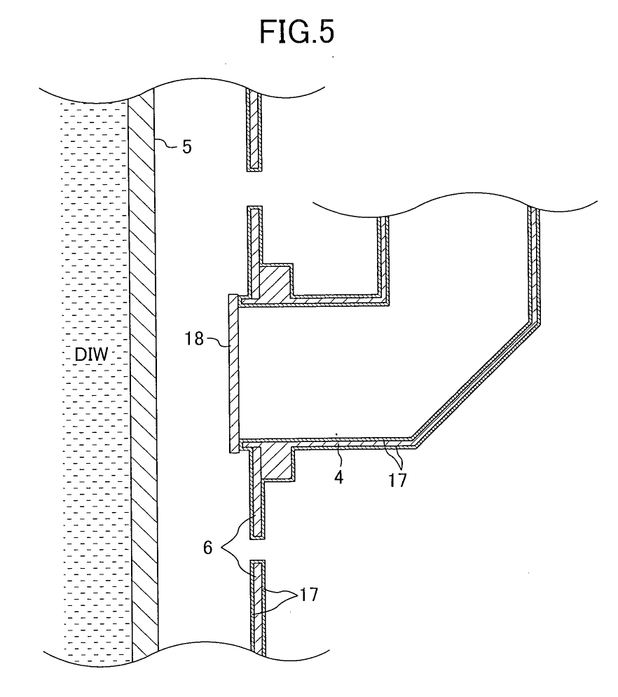

The waveguide 4 is made of a material that does not allow microwaves to penetrate therethrough and be absorbed therein but reflects microwaves. The microwave blocking plate 6 is also made of a material that reflects microwaves without allowing microwaves to penetrate therethrough like the waveguide 4. Although a metal material is typically used as the material that reflects microwaves, in particular, aluminum or copper is preferably used as constituent materials of the waveguide 4 and the microwave blocking plate 6. However, when the hot water production apparatus is placed in a cleaning apparatus for semiconductor devices and the metal material is used as the material that reflects microwaves, a chemical atmosphere in the cleaning apparatus might attack the metal material. Therefore, as shown in FIG. 5, a coating 17 made of a chemical-resistant material through which microwaves penetrate is applied to the inner and outer surfaces of the waveguide 4 and the microwave blocking plate 6. This can prevent the metal material from being attacked.

FIG. 5 is an enlarged cross-sectional view showing the vicinity of a microwave exit of the waveguide 4 of the hot water production apparatus of this embodiment when pure water is stored in the pure water tank 5. As shown in FIG. 5, a chemical atmosphere blocking plate (chemical-agent barrier) 18 of a chemical-resistant material through which microwaves penetrate is mounted inside the waveguide 4 or on the microwave exit face of the waveguide 4. This can prevent a vaporized chemical agent in a cleaning apparatus from diffusing through the waveguide 4 into the magnetron 2 and attacking the magnetron 2. Chemical-resistant materials which are suitable for the coating 17 and chemical atmosphere blocking plate 18 and through which microwaves penetrate include fluoroplastic (PFA, PTFE or the like). As shown in FIG. 5, the microwave exit of the waveguide 4 need not make contact with the wall surface of the pure water tank 5. However, in order to prevent the leakage of microwaves, it need be located on the inside of the chemical atmosphere blocking plate 18 (toward the pure water tank 5 side beyond the microwave blocking plate 6).

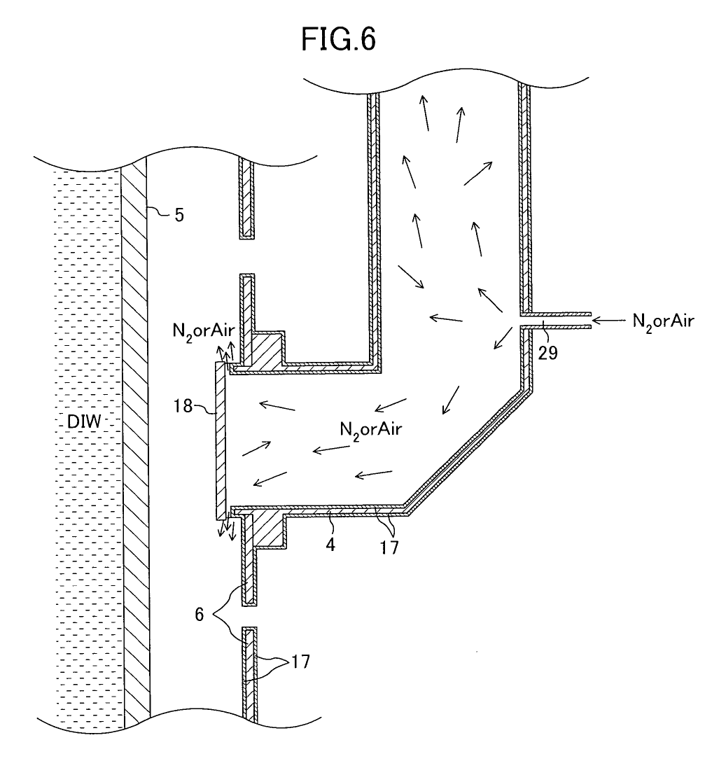

In order to prevent a chemical atmosphere in the cleaning apparatus from entering into the waveguide 4, as shown in FIG. 6, a gas inlet duct 29 having a diameter of a quarter or less of the microwave wavelength is attached to the waveguide 4. A gas, such as air, is taken from this gas inlet duct 29 into the waveguide 4 to provide a positive pressure in the waveguide 4. This can more effectively prevent a chemical atmosphere from entering into the waveguide 4. The gas taken into the waveguide 4 need only have a flow rate of approximately 1 L/min. The intake of the gas allows the gas to escape from cracks in joints or other parts of the waveguide 4. This can prevent the entry of the chemical atmosphere from these cracks. It is relatively difficult to apply a chemical-resistant coating to the inner surface of the waveguide 4 in contrast to the application of a chemical-resistant coating to the outer surface of the waveguide 4. The use of the above-mentioned method in which a gas is taken into the waveguide 4 almost prevents the chemical atmosphere from entering into the waveguide 4. Therefore, a chemical-resistant coating need not be applied to the inner surface of the waveguide 4.

If an inactive gas, such as nitrogen, is used as a gas taken from the gas inlet duct 29, this cannot only prevent the inside of the waveguide 4 and the magnetron 2 from being exposed to the chemical atmosphere but also can prevent the inside of the waveguide 4 from being attacked by the taken gas. This widens the range of choice of metals used for the waveguide 4.

The microwave blocking plate 6 may have a flat shape. However, it preferably has a shape with punched holes, because the status of the inside of the pure water tank 5 can be visually checked. In this case, the diameter of each punched hole is set at a quarter or less of the microwave wavelength, which allows microwaves to be blocked.

A material through which microwaves penetrate and with which liquid stored in the pure water tank 5 is not contaminated is used as a material of the pure water tank 5. The reason for this is that very-high-purity pure water is required to prepare a cleaning solution for semiconductor devices. Representative materials of the pure water tank 5 include quartz and fluoroplastic (PFA, PTFE or the like). Although both quartz and fluoroplastic permit the penetration of microwaves, they have different properties. If quartz is used as a material of the pure water tank 5, not only pure water but also most acids other than a hydrofluoric acid and alkalis can be used for the cleaning solution, and the transparency of quartz allows the status of the inside of the pure water tank 5 to be visually checked. On the other hand, if fluoroplastic is used as a material of the pure water tank 5, most acids including hydrofluoric acid and alkalis can be used for the cleaning solution. Therefore, a material of the pure water tank 5 need be selected in accordance with intended purposes.

The pure water tank 5 is sealed except for holes which are located in the top section of the pure water tank 5 and through which the supply pipe 7 and various sensors pass. In order to seal the pure water tank 5, a lid may be provided. Alternatively, it is also possible that through holes are opened in the top section and parts of the pure water tank 5 making contact with the pipe and sensors are welded. The exit of the waveguide 4 is placed in the vicinity of at least one of the top section, the side sections and the bottom section of the pure water tank 5. In this way, the pure water in the pure water tank 5 is heated in a non-contact manner by applying microwaves to the pure water past at least one of the top section of the pure water tank 5, the side sections thereof and the bottom section thereof.

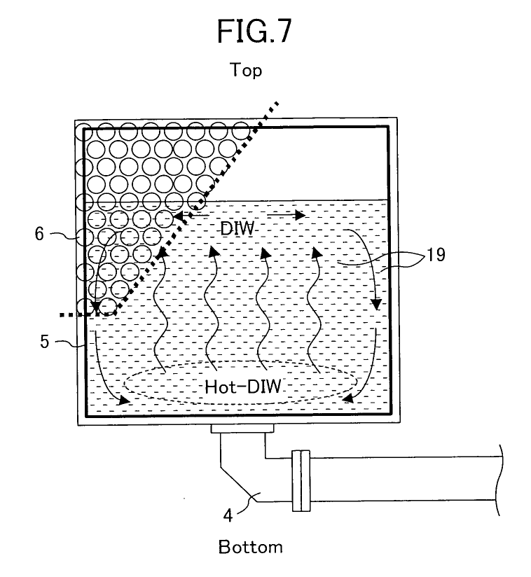

FIG. 7 is a schematic view showing the hot water production apparatus of this embodiment when microwaves are applied to pure water past the bottom section of a pure water tank. If as shown in FIG. 7 microwaves are applied to the pure water past the bottom section of the pure water tank 5, the pure water located in the vicinity of the bottom section is heated to reduce its specific gravity and thereby move upward in the pure water tank 5. Therefore, convection 19 of the pure water is automatically caused in the pure water tank 5. This permits uniform increase in the temperature of the pure water in the pure water tank 5. Otherwise, a plurality of waveguides 4 may be mounted to apply microwaves to the pure water past two or more parts of the pure water tank 5. This structure is effective, in particular, when the pure water tank 5 has a large capacity or when hot water is to be produced at high speed. For example, when microwaves are applied to the pure water from two directions, the frequencies of the microwaves are 2.44 GHz and 2.46 GHz, respectively. The reason why plural types of microwaves of different frequencies are used is that a plurality of microwaves are prevented from being cancelled by the interference from one another.

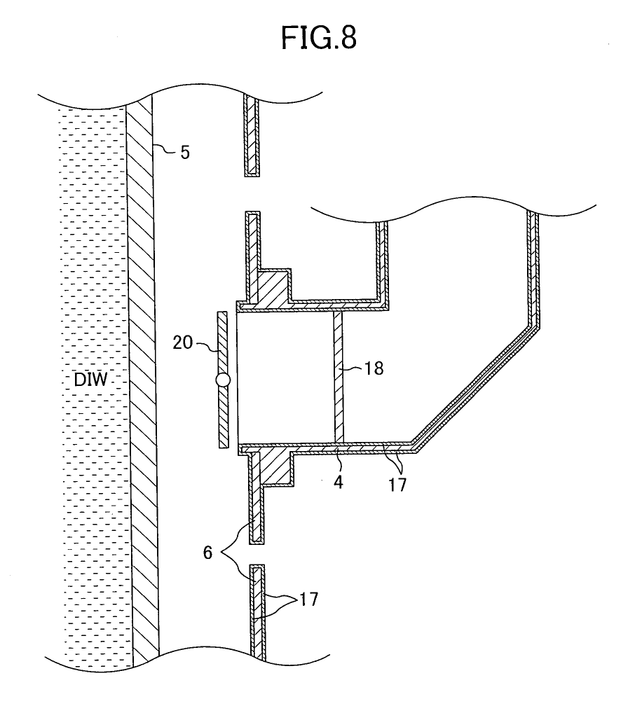

FIG. 8 is an enlarged cross-sectional view showing the hot water production apparatus of this embodiment when a stirrer for microwave scattering is attached to the exit of the waveguide 4. As shown in FIG. 8, a stirrer 20 for scattering microwaves may be attached to the exit of the waveguide 4. This stirrer 20 is made of a material that reflects microwaves, such as aluminum, SUS (Stainless Used Steel) and copper, and can rotate about an axis. With this structure, microwaves emitted from the exit of the waveguide 4 are scattered by the stirrer 20 so as to be applied to pure water in the pure water tank 5. This widens heatable part of the pure water, resulting in the more uniformly increased temperature of the pure water in the pure water tank 5. FIG. 8 shows an example of the hot water production apparatus when the rotation axis of the stirrer 20 is located on the center line of the waveguide 4. The rotation axis of the stirrer 20 may be shifted from the center line of the waveguide 4. This facilitates the operation of the stirrer 20.

A cleaning solution quantity of about 35 L is generally required for cleaning apparatuses for cleaning 8-inch semiconductor substrates. Therefore, about 35 liters of pure water is to be heated also in the pure water tank 5 for producing hot water. A cleaning solution is typically used which has been heated to about 70° C. As seen from the above, about 80 through 85° C. Hot water is required to prepare a cleaning solution. For example, in order to heat pure water from room temperature (25° C.) To 85° C. The temperature of the pure water is increased by 60° C. (=85−25). This requires a heat quantity of 4.18 cal/(g° C.)×60° C.×35000 g=8778 kcal. When the pure water is to be heated for 30 minutes, a necessary heat quantity can be calculated as follows: 8778 kcal/(30×60 sec)=4.88 kW. In this case, it can be determined that a microwave oscillator 1 and a magnetron 2 having a power of 4.88 kW or more, for example, a 6-kW product, is required for hot water production. This can be expressed in the following formula:
P=4.18×W×C×ΔT/t[Watt]
P: magnetron power required for hot water production, W: pure water weight [g], C: specific heat of pure water [cal/(g° C.)], ΔT: elevated temperature [° C.], t: time during which temperature is elevated

After the temperature of the pure water in the pure water tank 5 reaches a predetermined temperature, the power of the microwave oscillator 1 is controlled to maintain hot water in the pure water tank 5 at a predetermined temperature. For example, power of the microwave oscillator 1 required to restore the temperature of 35-liter hot water to the predetermined temperature within a maximum range of 0.5° C. In 60 seconds can be calculated as 1.2 kW. Thus, it can be seen that, when a 6-kW product is used, the temperature of the hot water in the pure water tank 5 can sufficiently be controlled under 1.2 kW/6 kW=20% of the power of the product.

In order to prepare a hot cleaning solution using hot water heated to a predetermined temperature, the hot water drained from the drain 8 is put into a separate preparation tank or cleaning tank with a cleaning solution, and the hot water and the chemical solution are mixed at a predetermined mixing ratio. Thereafter, semiconductor substrates are put into a cleaning tank containing this cleaning solution and immersed in the cleaning solution for a predetermined period, thereby cleaning the semiconductor substrates.

As described above, according to the hot water production apparatus of this embodiment shown in FIGS. 1 through 8, microwaves are applied to the tank in which pure water is stored to heat the pure water, thereby producing hot water. In this way, water molecules in the pure water are directly heated in a non-contact manner without using a heat conduction system. This can prevent metal contaminants from entering from a heater into the pure water and increase the heating efficiency as compared with the known method. Furthermore, since in this embodiment the generated heat in the vicinity of the pure water tank 5 can be reduced as compared with the use of an infrared lamp, the pure water tank 5 or the whole hot water production apparatus including the pure water tank 5 can be incorporated into the cleaning apparatus for semiconductor devices. Therefore, according to the hot water producing apparatus of this embodiment, space for the whole cleaning apparatus can be saved.

According to the hot water production apparatus of this embodiment, operations, such as an instant starting of application of microwaves and an instant stop thereof, can be performed. Therefore, the use of this hot water production apparatus permits heating with more excellent responsibility than the use of a heating apparatus of a heat conduction system, resulting in the improved temperature controllability. Furthermore, since the pure water tank need not be opened during the maintenance or exchange of the magnetron, this facilitates operations for the maintenance or exchange and can prevent contaminants from entering into the water due to the operations.

Although in this embodiment a description was given of the case where pure water is heated to produce hot water, the structure of the hot water production apparatus of this embodiment also permits the heating of a prepared cleaning solution stored in a preparation tank. Alternatively, the heated pure water in the pure water tank of this embodiment may be mixed with a chemical solution or a plurality of cleaning solutions to prepare a cleaning solution and then the prepared cleaning solution may be delivered to the cleaning tank.

With the cleaning apparatus, methods for obtaining a heated cleaning solution include a method in which a chemical solution is mixed into a heated pure water, a method in which, after a chemical solution is mixed into pure water to prepare a cleaning solution, the cleaning solution is heated, and a method in which a heated chemical solution is mixed into heated pure water to prepare a cleaning solution. The above-mentioned structure of the heating apparatus in which liquid is heated in a non-contact manner by microwaves is applicable to the heating of any of a chemical solution, a cleaning solution and pure water.

### Embodiment 2

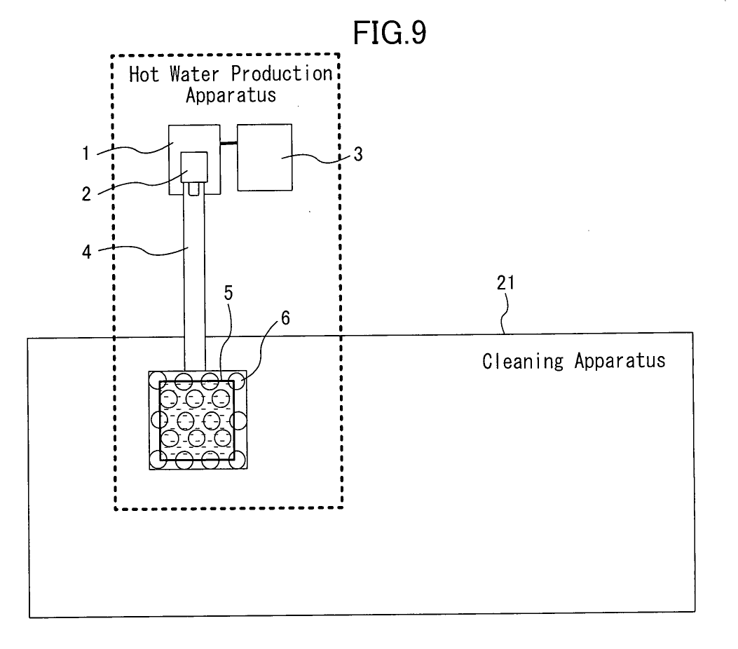

FIG. 9 is a schematic view showing an example of a cleaning apparatus and a hot water production apparatus according to a second embodiment of the present invention.

The hot water production apparatus shown in FIG. 9 is identical with the hot water production apparatus of the first embodiment shown in FIG. 1 but is characterized in that a microwave oscillator 1, a power supply 3 and a part of a waveguide 4 are placed outside the cleaning apparatus for cleaning semiconductor devices.

A hot water production apparatus of this embodiment comprises a pure water tank 5, a power supply 3, the microwave oscillator 1 connected through a cable to the power supply 3 and having a magnetron 2 that generates microwaves, the waveguide 4 that transmits microwaves generated from the microwave oscillator 1 to the pure water tank 5 and irradiates the pure water tank 5 with microwaves, and a microwave blocking plate 6 surrounding the entire surfaces of the pure water tank 5 to prevent the leakage of microwaves. Some members, such as a supply pipe 7, a drain 8, a liquid-level sensor 9, a temperature-measuring sensor 10, and choke pipes 11 are not shown.

In the hot water production apparatus of this embodiment, the pure water tank 5 and the microwave blocking plate 6 are placed inside a cleaning apparatus 21 while the microwave oscillator 1 having the magnetron 2 and the power supply 3 are placed outside the cleaning apparatus 21. The microwave oscillator 1 (magnetron 2) is connected through the waveguide 4 to the pure water tank 5.

In order to heat pure water stored in the pure water tank 5, the power supply 3 placed outside the cleaning apparatus 21 is turned ON to operate the microwave oscillator 1, thereby generating microwaves from the magnetron 2. The generated microwaves are delivered through the inside of the waveguide 4 to the pure water tank 5 placed inside the cleaning apparatus 21 and applied to pure water in the pure water tank 5. In this way, the pure water is heated in a non-contact manner. The other basic operations are identical with those described in the first embodiment of the present invention.

As seen from the above, in the hot water production apparatus and the cleaning apparatus of this embodiment, the pure water tank 5 and the microwave blocking plate 6 are placed inside the cleaning apparatus 21, the microwave oscillator 1 having the magnetron 2 and the power supply 3 are placed outside the cleaning apparatus 21, and the microwave oscillator 1 is connected through the waveguide 4 to the pure water tank 5. Thus, only essential members are placed inside the cleaning apparatus 21. This can make the cleaning apparatus 21 itself compact and improve the flexibility in design for placing the cleaning apparatus 21 inside a clean room.

### Embodiment 3

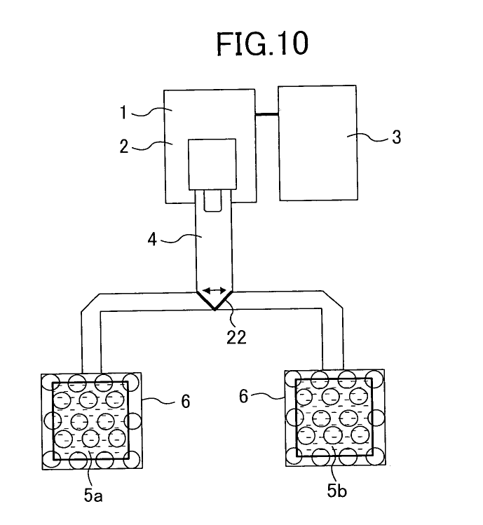

FIG. 10 is a schematic view showing an example of a hot water production apparatus according to a third embodiment of the present invention.

A hot water production apparatus of this embodiment comprises a first pure water tank 5a, a second pure water tank 5b, a power supply 3, a microwave oscillator 1 connected through a cable to the power supply 3 and having a magnetron 2 that generates microwaves, a waveguide 4 that transmits microwaves generated from the microwave oscillator 1 to the first and second pure water tanks 5a and 5b and irradiates the first and second pure water tanks 5a and 5b with microwaves, a reflector (microwave reflector element) 22 disposed at a branch point of the waveguide 4 and made of a material that reflects microwaves, and a microwave blocking plate 6 surrounding the entire surfaces of the first and second pure water tanks 5a and 5b to prevent the leakage of microwaves. The hot water production apparatus of this embodiment is characterized by applying microwaves generated by the one magnetron 2 to two or more pure water tanks.

According to the hot water production apparatus of this embodiment, in order to heat pure water stored in the first pure water tank 5a, the power supply 3 is turned ON to operate the microwave oscillator 1, thereby generating microwaves from the magnetron 2. Next, the reflector 22 disposed at a branch point of the waveguide 4 is turned from the first pure water tank 5a side toward the second pure water tank 5b side to reflect microwaves, thereby transmitting microwaves toward the first pure water tank 5a. Thus, microwaves are applied from the exit of the waveguide 4 located at the first pure water tank 5a side to the first pure water tank 5a. As a result, the pure water in the first pure water tank 5a can be heated in a non-contact manner.

In order to heat pure water stored in the second pure water tank 5b after the heating of pure water in the first pure water tank 5a to a predetermined temperature, the reflector 22 disposed at the branch point of the waveguide 4 is turned from the second pure water tank 5b side toward the first pure water tank 5a side. In this way, the direction in which microwaves reflected on the reflector 22 is transmitted is switched to transmit the microwaves to the second pure water tank 5b. Thus, microwaves are applied from the exit of the waveguide 4 located at the second pure water tank 5b side to the second pure water tank 5b, thereby heating the pure water in the second pure water tank 5b in a non-contact manner.

In order to control the temperature of hot water in the first pure water tank 5a also during the heating of pure water in the second pure water tank 5b, the reflector 22 disposed in the waveguide 4 is operated as necessary to apply microwaves to the first pure water tank 5a. If microwaves are thus applied to the first or second pure water tank 5a or 5b with the traveling direction of microwaves switched as necessary, this can make it possible to heat pure water in the first and second pure water tanks 5a and 5b simultaneously or with a time lag and control the temperature of the pure water therein simultaneously.

A description was given of the case where two pure water tanks are provided for the hot water production apparatus of this embodiment. However, even when three or more pure water tanks are provided, pure water can be heated likewise. The other basic operations and structures are identical with those described in the first embodiment of the present invention.

As seen from the above, according to the hot water production apparatus of this embodiment shown in FIG. 10, microwaves generated by the one magnetron 5 are switched by the reflector 22 so as to be applied to two or more pure water tanks. This can decrease the number of magnetrons, oscillators and power supplies and reduce the investment cost for hot water production apparatuses and the maintenance cost therefor. Furthermore, the space occupied by a hot water production apparatus can be reduced.

Even when the waveguide 4 has a length of a few tens of m (for example, 30 m), microwaves hardly attenuate. This permits the routing of the waveguide 4 and increases the flexibility in installing the hot water production apparatus.

Although in this embodiment an apparatus for producing hot water by heating pure water was described, a cleaning or chemical solution prepared in a preparation tank can also be heated as described above.

### Embodiment 4

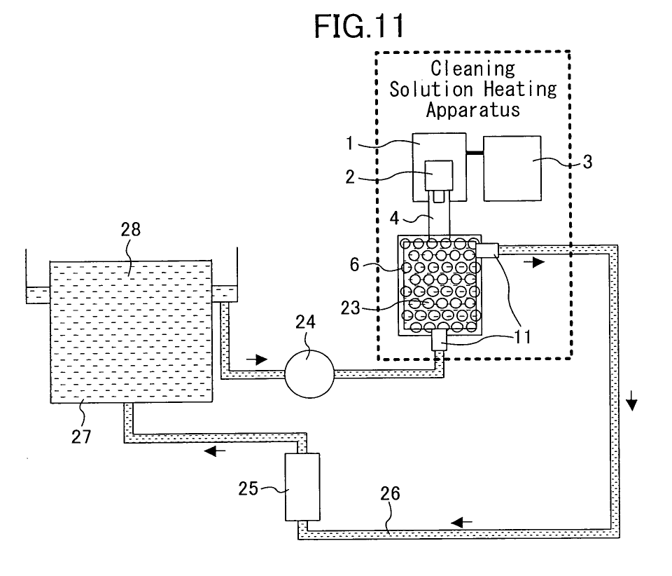

FIG. 11 is a schematic view showing an example of a cleaning solution heating apparatus and a cleaning apparatus according to a fourth embodiment of the present invention. The cleaning solution heating apparatus and the cleaning apparatus of this embodiment are characterized by heating a cleaning solution located in a cleaning tank through a circulating line including a heating tank 23.

The cleaning apparatus of this embodiment shown in FIG. 11 comprises a cleaning tank 27 for storing a cleaning solution 28, a circulating line (pipe) 26 for circulating the cleaning solution 28 stored in the cleaning tank 27, a cleaning solution heating apparatus placed in the circulating line 26 and including a heating tank 23 for heating the cleaning solution 28, a circulating pump 24 placed somewhere along the circulating line 26 to deliver the cleaning solution 28, and a filter 25 that is placed in the circulating line 26 and is for removing particles in the cleaning solution 28. The cleaning tank 27 is separated into, for example, an inner tank and an outer tank.

The cleaning solution heating apparatus is obtained by replacing the pure water tank of the hot water production apparatus shown in FIG. 1 with a heating tank 23 and comprises, in addition to the heating tank 23, a power supply 3, a microwave oscillator 1 connected through a cable to the power supply 3 and having a magnetron 2 that generates microwaves, a waveguide 4 that transmits the microwaves generated from the microwave oscillator 1 to the heating tank 23 and irradiates the heating tank 23 with microwaves, a microwave blocking plate 6 surrounding the entire surfaces of the heating tank 23 and preventing the leakage of microwaves, and microwave-leakage-preventing choke pipes 11 placed at the joints between the heating tank 23 and the circulating line 26. The microwave oscillator 1, the power supply 3 and the waveguide 4 may be placed inside the cleaning apparatus or outside the cleaning apparatus.

In the cleaning apparatus of this embodiment, the cleaning solution 28 flows from the outer tank of the cleaning tank 27 into the circulating line 26, then passes through the circulating pump 24 and is delivered to the heating tank 23 located in the cleaning solution heating apparatus. In the heating tank 23, microwaves generated from the magnetron 2 located in the microwave oscillator 1 passes through the inside of the waveguide 4 and penetrates through the heating tank 23 so as to be applied to the cleaning solution 28. In this way, the cleaning solution 28 is heated. The heated cleaning solution 28 flows from the heating tank 23 into the circulating line 26 to reach the filter 25. Particles in the cleaning solution 28 are removed by the filter 25, and then the cleaning solution 28 returns to the inner tank of the cleaning tank 27. The repetition of the above procedure allows the cleaning solution 28 to be heated while being circulated. The temperature of the cleaning solution 28 is controlled by controlling the oscillatory power of microwaves to maintain the cleaning solution 28 at a predetermined temperature.

There is used, as the cleaning solution 28 for cleaning semiconductor substrates, cleaning solutions obtained by blending two or three kinds of solutions selected from the group of alkaline chemical solutions such as ammonia water, acidic chemical solutions such as sulfuric acid and hydrochloric acid, oxidizing-agent chemical solutions such as hydrogen peroxide and ozone water, and pure water at a predetermined mixing ratio. Since commercial alkaline and acidic chemical solutions are mostly aqueous solutions, the cleaning solution 28 is also an aqueous solution. Therefore, the application of microwaves to the cleaning solution 28 allows water molecules in the cleaning solution 28 to vibrate and thus generate heat, resulting in the heated cleaning solution 28.

In order to effectively remove contaminants, such as particles and metal impurities, from the top surfaces of semiconductor substrates in a shorter time with the cleaning efficiency of the cleaning solution improved, a cleaning solution is to be used which has been heated to a predetermined temperature, for example, 70° C. In this relation, in order to shorten the period required for the heating of a cleaning solution, it is typical that a cleaning solution previously heated in a preparation tank or previously heated hot water and a previously heated chemical solution are supplied to a cleaning tank. Therefore, in many cases, the heating of the cleaning solution in the cleaning tank increases the temperature of the cleaning solution by about 2 through 3° C. To control the temperature thereof or increases the temperature thereof at the time of the supply thereof by about 10° C. Therefore, a high-power microwave oscillator is not required. The temperature of the cleaning solution can sufficiently be increased by, for example, a several-kW low-power microwave oscillator.

According to the cleaning apparatus of the present invention, microwaves are applied not to the cleaning solution 28 with a pipe for the circulating line 26 interposed therebetween but to the cleaning solution 28 temporarily stored in the heating tank 23. Therefore, the cleaning solution 28 can more effectively be heated by an inexpensive lower-power microwave oscillator 1. When microwaves are applied to the cleaning solution 28 with the pipe for the circulating line 26 interposed therebetween, the flow velocity of the cleaning solution 28 is so fast that the cleaning solution 28 can stay at the site to which microwaves are applied only for a short time. This makes it difficult to increase the temperature of the cleaning solution 28 to a desired temperature without increasing the microwave power. As a result, according to the known heating method, an expensive high-power microwave oscillator is required. On the other hand, according to the heating method of the present invention, the temporary storage of the cleaning solution 28 in the heating tank 23 sharply decreases the flow velocity of the cleaning solution 28 in the heating tank 23. This can increase the period during which microwaves are applied to the cleaning solution 28. As a result, a cleaning solution can be heated using an inexpensive lower-power microwave oscillator.

It is difficult that the pipe of the circulating line 26 for the cleaning solution 28, which is connected to the heating tank 23, has a diameter of a quarter or less of the microwave wavelength, which allows microwaves to be blocked. The reason for this is that a flow rate of 10 through 20 L/min is usually required for the circulating line 26. In view of the above, if the choke pipes 11 are attached to pipe joints for the circulating line 26, this reduces the leakage of microwaves from these joints.

Furthermore, as described above, the waveguide 4 must be made of a material that does not allow microwaves to penetrate therethrough and be absorbed therein but reflects microwaves. The microwave blocking plate 6 must also be made of a material that reflects microwaves without allowing microwaves to penetrate therethrough and be absorbed therein like the waveguide 4. Therefore, metals are used as materials of the waveguide 4 and the microwave blocking plate 6. In order to prevent the waveguide 4 and the microwave blocking plate 6 from being attacked due to a chemical atmosphere in the cleaning apparatus, a coating made of a chemical-resistant material through which microwaves penetrate (for example, fluoroplastic) is preferably applied to the inner and outer surfaces of the waveguide 4 and the microwave blocking plate 6.

The heating tank 23 is made of a material through which microwaves penetrate and which does not dissolve into the cleaning solution 28 and react with the cleaning solution 28 and can provide high cleanliness to the extent that the material can be used for the purpose of cleaning semiconductor substrates (for example, quartz or fluoroplastic). Microwaves are applied through at least one of the top of the heating tank 23, the sides thereof and the bottom thereof to the heating tank 23. If microwaves are applied to the cleaning solution 28 in the direction opposed to the flow direction of the cleaning solution 28 (i.e., through the top of the heating tank 23), the cleaning solution 28 can more effectively be heated.

FIG. 11 shows the state where semiconductor substrates are not put into the cleaning tank 27. However, since an object of the present invention is to heat the cleaning solution 28, it is needless to say that the cleaning solution 28 can be heated to control the temperature of the cleaning solution 28 also during the cleaning of semiconductor substrates immersed into the cleaning tank 27.

As seen from the above, according to the cleaning apparatus of this embodiment shown in FIG. 11, the cleaning solution 28 is temporarily stored in the heating tank 23 in the circulating line 26 of the cleaning solution 28, and microwaves are applied to the stored cleaning solution 28 to heat the cleaning solution 28. Since the flow velocity of the cleaning solution 28 thus decreases, this increases the period during which microwaves are applied to the cleaning solution 28. As a result, the cleaning solution 28 can effectively be heated even by an inexpensive low-power microwave oscillator 1.

The heating of the cleaning solution 28 in a non-contact manner can prevent metal contaminants from entering from a heater into the cleaning solution 28 and can provide a high heating efficiency. Furthermore, since the generated heat in the vicinity of the heating tank 23 can be reduced, the cleaning solution heating apparatus can be placed in the cleaning apparatus. As a result, space for the cleaning apparatus can be saved. In addition, since heating can instantly be started or stopped with the starting or stop of application of microwaves, this can provide excellent response to a heating operation as compared with the heating method using thermal conductivity and improve the temperature controllability. Furthermore, since the circulating line 26 need not be opened during the maintenance and exchange of the magnetron 2, this facilitates operations for the maintenance and exchange thereof and can prevent contaminants from entering into the cleaning solution 28 due to the operations.

As described above, the liquid heating apparatus of the present invention is widely used not only for the purpose of providing a heated cleaning solution for semiconductor substrates or the like but also for the purpose of heating liquid including water.

What is claimed is:

1. A liquid heating apparatus comprising:
a first reservoir for storing a first liquid;
a supply passage for supplying the first liquid to the first reservoir;
a drain for draining the first liquid from the first reservoir;
a microwave oscillator for generating microwaves that can heat the first liquid;
a waveguide for transmitting microwaves to the first reservoir and applying microwaves to the first liquid past the first reservoir; and
a microwave blocker for preventing microwaves from leaking out of the first reservoir.

2. The liquid heating apparatus of claim 1, further comprising
a choke pipe attached to at least one of joints between the supply passage and the first reservoir and between the drain and the first reservoir and preventing the leakage of the microwave.

3. The liquid heating apparatus of claim 1, wherein
at least one of the supply passage and the drain has a plurality of branches at the joint with the first reservoir, the diameter of each said branch being a quarter or less of the microwave wavelength.

4. The liquid heating apparatus of claim 1, further comprising
a chemical-agent barrier of a chemical-resistant material attached to a microwave radiation exit of the waveguide to prevent a chemical solution from entering into the waveguide.

5. The liquid heating apparatus of claim 1, further comprising
a stirrer attached to a microwave radiation exit of the waveguide to scatter microwaves applied to the first reservoir.

6. The liquid heating apparatus of claim 1, wherein
the inner and outer surfaces of the waveguide are coated with a chemical-resistant material.

7. The liquid heating apparatus of claim 1, wherein
a gas inlet duct is provided for the waveguide, and a gas is taken from the gas inlet duct to provide a positive pressure inside the waveguide.

8. The liquid heating apparatus of claim 7, wherein
the gas is an inert gas.

9. The liquid heating apparatus of claim 1, wherein
the microwave blocker is coated with a chemical-resistant material.

10. The liquid heating apparatus of claim 1, further comprising:
a second reservoir for storing a second liquid;
a branch waveguide that is branched from the waveguide to transmit microwaves generated by the microwave oscillator to the second reservoir and apply the microwaves to the second liquid past the second reservoir; and
a movable microwave reflector element disposed at the junction between the waveguide and the branch waveguide and made of a material that reflects microwaves.

11. The liquid heating apparatus of claim 1, wherein
the waveguide is made of a metal material.

12. The liquid heating apparatus of claim 1, wherein
the microwave blocker is made of a metal material.

13. The liquid heating apparatus of claim 1, wherein
the first reservoir is made of fluoroplastic or quartz.

14. The liquid heating apparatus of claim 4, wherein
the chemical-agent barrier is made of fluoroplastic.

15. The liquid heating apparatus of claim 1, wherein
the waveguide is connected to the bottom of the reservoir.

16. A cleaning apparatus comprising a liquid heating unit for heating liquid and a cleaning unit having a cleaning tank for storing a cleaning solution,
wherein the liquid heating unit comprises:
a reservoir mounted in the cleaning unit to store liquid;
a supply passage for supplying the liquid to the reservoir;
a drain for draining the liquid from the reservoir;
a microwave oscillator for generating microwaves that can heat the liquid; and
a waveguide for transmitting microwaves to the reservoir and applying the microwaves to the liquid past the reservoir.

17. The cleaning apparatus of claim 16, wherein
the whole liquid heating unit is placed in the cleaning unit.

18. The cleaning apparatus of claim 16, wherein
the liquid stored in the reservoir is one selected from the group of pure water, chemical solutions and the cleaning solution.

19. The cleaning apparatus of claim 16, further comprising
a circulating line which is connected to the cleaning tank and through which the cleaning solution in the cleaning tank circulates,
wherein the reservoir is placed somewhere along the circulating line and stores the cleaning solution circulated through the circulating line.

20. A cleaning method using a cleaning apparatus comprising a reservoir for storing liquid, a cleaning unit having a cleaning tank for storing a cleaning solution, a microwave oscillator for generating a first type of microwaves that can heat the liquid, a waveguide for transmitting the first type of microwaves to the reservoir and applying the first type of microwaves to the liquid past the reservoir, said method comprising the steps of:
(a) storing the liquid in the reservoir;
(b) applying the first type of microwaves to the liquid in the reservoir to heat the liquid;
(c) delivering the liquid heated in the step (b) to the cleaning tank; and
(d) storing the cleaning solution containing the liquid to the cleaning tank and cleaning an object to be cleaned.

21. The cleaning method of claim 20, wherein
the liquid stored in the reservoir is the cleaning solution, and the cleaning solution in the reservoir is circulated through a circulating line including the reservoir.

22. The cleaning method of claim 20, wherein
the cleaning apparatus further comprises a first preparation tank, and
the method further comprises the step of, before the step (a), preparing the cleaning solution in the first preparation tank and delivering the cleaning solution to the reservoir.

23. The cleaning method of claim 20, wherein
the step (a) includes the step of supplying pure water and a chemical solution to the reservoir, and the pure water and the chemical solution are mixed in the reservoir to prepare the cleaning solution.

24. The cleaning method of claim 20, wherein
the liquid stored in the reservoir is pure water, and
the method further comprises the step (e) of, between the steps (c) and (d), mixing the pure water and a chemical solution in the cleaning tank to prepare the cleaning solution.

25. The cleaning method of claim 20, wherein
the cleaning apparatus further comprises a second preparation tank,
the liquid stored in the reservoir is pure water, and
the method further comprises the steps of:
(f) delivering the heated pure water to the second preparation tank immediately after the step (b);
(g) mixing the pure water and a chemical solution in the second preparation tank to prepare the cleaning solution; and
(h) delivering the cleaning solution prepared in the step (g) to the cleaning tank.

26. The cleaning method of claim 20, wherein
in the step (b), a second type of microwaves with a different frequency from that of the first type of microwaves is applied to the liquid in the reservoir.
